(19) United States
(12) Patent Application Publication
(10) Pub. No.: US 2009/0107749 A1
(43) Pub. Date: Apr. 30, 2009

(54) Closed Loop Traction System for Light-Weight Utility Vehicles

(75) Inventors: Warren Clark, Evans, GA (US); Aric Singletary, Hephzibah, GA (US); Oliver A. Bell, Aiken, SC (US)

Correspondence Address: HARNESS, DICKEY & PIERCE, P.L.C., P.O. BOX 828, BLOOMFIELD HILLS, MI, 48303, US

(73) Assignee: TEXTRON INC., Providence, RI (US)

(21) Appl. No.: 11/928,437

(22) Filed: Oct. 30, 2007

(51) Int. Cl. B60K 28/16

(52) U.S. Cl. 180/197

(57) ABSTRACT

A traction control system for a light-weight utility vehicle is provided. The system includes a wheel speed sensor that generates a wheel speed signal in accordance with a rotational speed of a non-driven wheel of the utility vehicle. An accelerator position sensor generates an accelerator signal in accordance with a position of an accelerator pedal of the utility vehicle. A controller receives the wheel speed signal and the accelerator signal, determines an intended speed based on the accelerator signal, and determines a substantially actual wheel speed based on the wheel speed signal. Based on a comparison of the substantially actual wheel speed and the intended speed, the controller controls rotation of at least one driven wheel by adjusting at least one of a commanded speed and a commanded torque when the substantially actual wheel speed is outside of a desired range of the intended speed.

### FIELD

The present teachings relate to controlling traction on light-weight utility vehicles.

### BACKGROUND

Traction control deals specifically with lateral (front-to-back) loss of friction during acceleration of a vehicle. When an electric car accelerates from a dead stop, or speeds up, traction control works to ensure maximum contact between the surface and the tires, even under less-than-ideal surface conditions. For example, a wet or icy surface will significantly reduce the friction (traction) between the tires and the surface. Since the tires are the only part of the car that actually touch the surface, any resulting loss of friction can have consequences.

Traction control systems work similar to antilock braking systems (ABS), but deal with acceleration instead of deceleration. Modern vehicles use the same wheel-speed sensors employed by the ABS for traction control systems. These sensors measure a rotational speed of each wheel. The rotational speeds are compared to determine if a wheel has lost traction. When the traction control system determines that one wheel is spinning more quickly than the others, the system applies a braking force to the slipping wheel to lessen wheel slip. In most cases, individual wheel braking is enough to control wheel slip. However, some traction-control systems also reduce engine power to the slipping wheels.

Using existing wheel-speed sensors to control traction on vehicles seems to be an economical solution. The only added cost for implementing the feature is embedded in software that controls the system. This solution, however, is not economical for vehicles without ABS components, for instance, a light-weight utility vehicle. Adding a wheel-speed sensor to each wheel of the light-weight utility vehicle for comparison purposes of a traction control system can be costly.

### SUMMARY

Accordingly, a traction control system for a light-weight utility vehicle is provided. The system includes a wheel speed sensor that generates a wheel speed signal in accordance with a rotational speed of a non-driven wheel of the utility vehicle. An accelerator position sensor generates an accelerator signal in accordance with a position of an accelerator pedal of the utility vehicle. A controller receives the wheel speed signal and the accelerator signal, determines an intended speed based on the accelerator signal, and determines a substantially actual wheel speed based on the wheel speed signal. Based on a comparison of the substantially actual wheel speed and the intended speed, the controller controls rotation of at least one driven wheel by adjusting at least one of a commanded speed and a commanded torque when the substantially actual wheel speed is outside of a desired range of the intended speed.

In other features, a traction control system for a light-weight utility vehicle includes a wheel speed sensor that generates a wheel speed signal in accordance with a rotational speed of a non-driven wheel of the utility vehicle. A motor speed sensor generates a motor speed signal in accordance with a rotational speed of a motor of the utility vehicle. A controller receives the wheel speed signal and the motor signal, determines a motor speed based on the motor speed signal, and determines a substantially actual wheel speed based on the wheel speed signal. Based on a comparison of the substantially actual wheel speed and the motor speed, the controller controls rotation of at least one driven wheel by adjusting at least one of a commanded speed and a commanded torque when the substantially actual wheel speed is outside of a desired range of the motor speed.

In still other features, a traction control method for light-weight utility vehicles is provided. The traction control method includes: processing an accelerator signal received from an accelerator position sensing device coupled to an accelerator pedal; processing a wheel speed signal received from a wheel speed sensing device coupled to a non-driven wheel; adjusting at least one of a commanded speed and a commanded torque when the wheel speed signal is outside of a desired range of the accelerator signal; and controlling a motor in accordance with the commanded speed and the commanded torque.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present teachings in any way.

FIG. 1 is a block diagram illustrating a light-weight utility vehicle including a traction control system, in accordance with various embodiments.

FIG. 2 is a block diagram illustrating the traction control system shown in FIG. 1, in accordance with various embodiments.

FIG. 3 is a flowchart illustrating a closed loop application of the traction control system shown in FIG. 1, in accordance with various embodiments.

FIG. 4 is a flowchart illustrating a closed loop application of the traction control system shown in FIG. 1, in accordance with various embodiments.

FIG. 5 is a flowchart illustrating a closed loop application of the traction control system shown in FIG. 1, in accordance with various embodiments.

FIG. 6 is a flowchart illustrating a closed loop application of the traction control system shown in FIG. 1, in accordance with various embodiments.

### DETAILED DESCRIPTION

The following description is merely exemplary in nature and is in no way intended to limit the present disclosure, application, or uses. For purposes of clarity, like reference numbers will be used in the drawings to identify like elements.

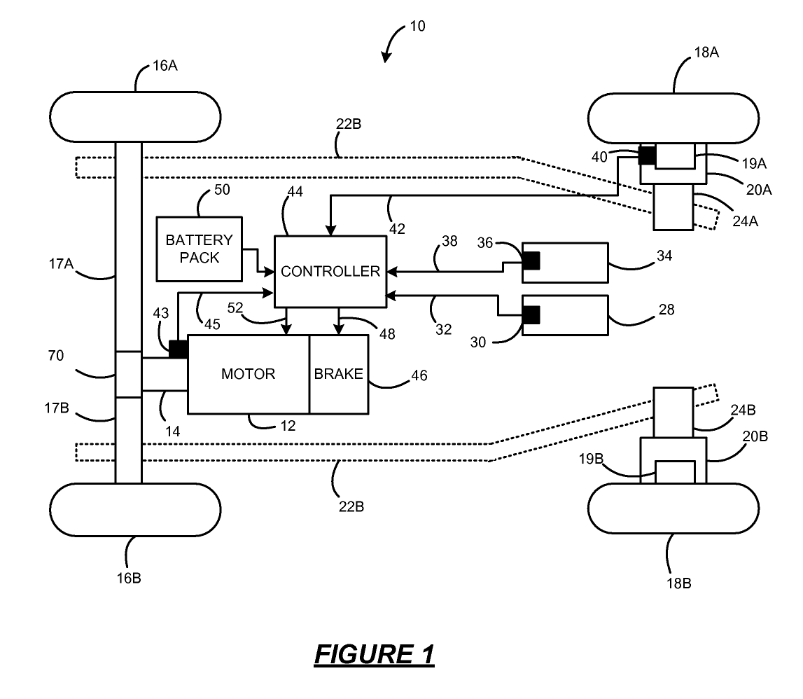

FIG. 1 is a block diagram illustrating a non-limiting, exemplary light-weight utility vehicle 10, including a traction control system in accordance with various embodiments. As shown in FIG. 1, the exemplary vehicle 10 is an electric vehicle. As can be appreciated, vehicle 10 can be any vehicle type, including but not limited to, gasoline, electric, and hybrid. In FIG. 1, a motor 12 couples through an output member 14, such as an output shaft, to an input shaft of rear axles 17A and 17B. A motor 12 drives rear wheels 16A and 16B coupled to axles 17A and 17B. Motor 12 can be any known electrical motor generator, and/or motor generator technology, including, but not limited to AC induction machines, DC machines, synchronous machines, and switched reluctance machines. Front non-driven wheels 18A and 18B couple to hubs 19A and 19B of wheel support assemblies 20A and 20B. Front non-driven wheels 18A and 18B and hubs 19A and 19B rotate about wheel support assemblies 20A and 20B. Wheel support assemblies 20A and 20B mount to frame 22A and 22B via suspension arms 24A and 24B.

An accelerator assembly includes an accelerator pedal 28 and an accelerator position sensor 30. Accelerator position sensor 30 generates an accelerator signal 32 based on a sensed position of accelerator pedal 28. A brake pedal assembly includes a brake pedal 34 and a brake position sensor 36. Brake position sensor 36 generates a brake signal 38 based on a sensed position of brake pedal 34. A motor speed sensor 43 couples to one of motor 12 and output member 14. Motor speed sensor 43 generates a motor speed signal 45 based on a rotational speed of motor 12. In various embodiments, motor speed sensor 43 is a bearing sensor.

A wheel speed sensor 40 couples to hub 19A. Wheel speed sensor 40 generates a wheel speed signal 42 in accordance with a rotational speed of front non-driven wheel 18A coupled to hub 19A. As can be appreciated, a front wheel support assembly 20B can be a mirror image of front wheel support assembly 20A. Wheel support assembly 20B may additionally or alternatively include a wheel speed sensor (not shown) coupled to hub 19B. The wheel speed sensor (not shown) generates a wheel speed signal (not shown) in accordance with a rotational speed of front non-driven wheel 18B.

As can be appreciated, wheel speed sensor 40 may be any known type of vehicle speed sensing mechanisms capable of generating a wheel speed signal, including but not limited to, variable reluctance sensors, Hall-effect sensors, optical switches, and proximity switches. In various embodiments, wheel speed sensor 40 may be implemented as an encoder built into a wheel bearing (not shown) coupled to front non-driven wheel 18A. The encoder may be mounted inside hub 19A. The encoder can include a movable member whose position is determined based upon a moving component of the bearing and a stationary member coupled to the moving member either optically, capacitively, or magnetically. The stationary member can include a number of sensors that provide the electrical output signals. The output signals can be processed to indicate any individual one or combination of a position, direction, speed, and acceleration of the movable member and hence the wheel.

By way of non-limiting example, an encoder which uses a number of Hall-effect sensors to magnetically detect indicia on the movable member will be discussed. The encoder includes a ring stationary to a shaft. A series of metallic strips separated by non-metallic caps can be embedded into a backing of the shaft. The encoder includes a Hall-effect chip that senses the presence of the metallic strips as the shaft rotates. Typically sixty-four metallic strips are embedded to produce sixty-four pulses per revolution. As non-driven wheel 18A rotates, pulses form wheel speed signal 42 and are sent to a controller 44 for calculation of a non-driven wheel speed. As can be appreciated, the non-driven wheel speed can be determined from wheel speed signals generated by one or both non-driven wheels 18A and 18B. For ease of the discussion, the disclosure will be discussed in the context of determining the non-driven speed from wheel speed signal 42.

Controller 44 controls a brake 46 and motor 12, in accordance with the traction control methods of the present teachings. Controller 44 controls brake 46 via a brake signal 48 to vary a braking force applied to motor 12. Controller 44 further controls voltage, current, and/or power provided to motor 12 from a battery pack 50, via a motor signal 52. Motor signal 52 is determined based on various signal inputs, such as, individually or collectively, accelerator signal 32, brake signal 38, motor speed signal 45, and wheel speed signal 42.

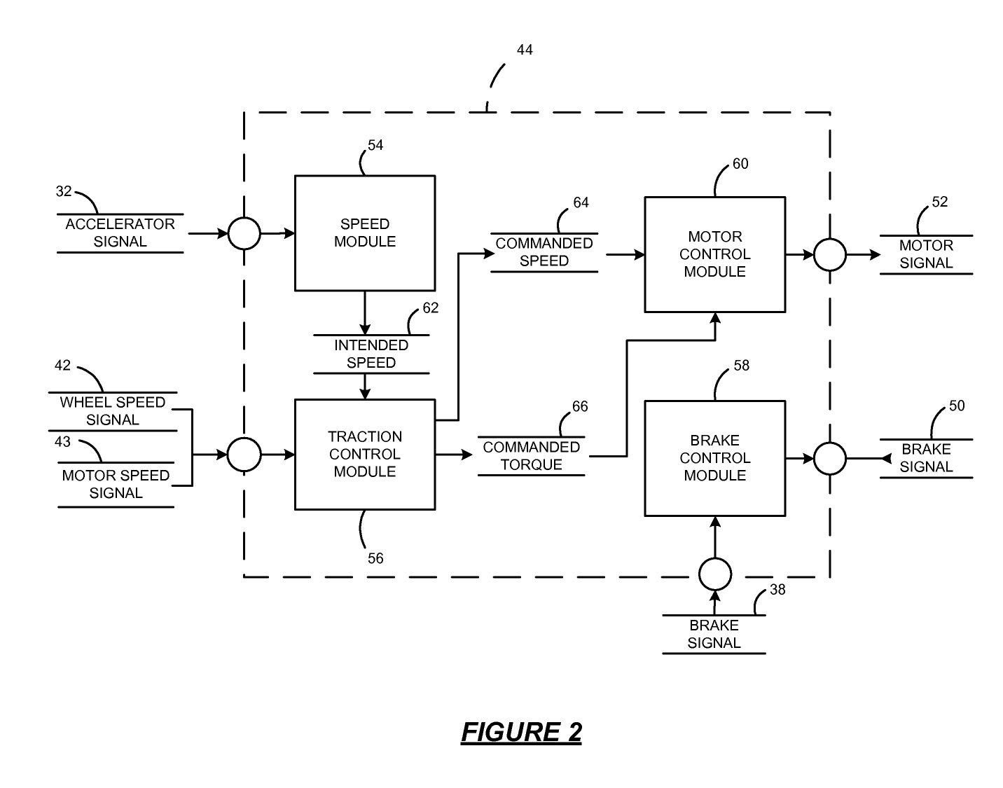

Referring to FIG. 2, as can be appreciated, controller 44 may be any known microprocessor, controller, or combination thereof known in the art. In various embodiments, controller 44 includes one or more input/output (I/O) devices, a microprocessor having read only memory (ROM), random access memory (RAM), and a central processing unit (CPU), and one or more device drivers. The microprocessor can include any number of software control modules or algorithms, executable by the microprocessor to provide the functionality for closed loop traction control of vehicle 10. The input/output device receives and processes signals from the sensors and or generates the appropriate signal to power the sensors. The device driver includes the power electronics for operating the motor, both as a motor and a generator, creating motoring and braking torque as required by the microprocessor. In various other embodiments, components of or the entire controller 44 can be implemented as an application specific integrated circuit (ASIC), an electronic circuit, a combinational logic circuit and/or other suitable components for performing closed loop traction control of vehicle 10.

FIG. 2 is a dataflow diagram illustrating a closed loop application of the traction control system shown in FIG. 1, in accordance with various embodiments. In the exemplary embodiment, the traction control system includes modules within controller 44. As can be appreciated, various embodiments of closed loop traction control systems may include any number of modules and sub-modules embedded within controller 44. The modules shown in FIG. 2 may be combined and/or further partitioned to similarly provide control of vehicle 10 during traction events, as will be discussed further below.

In various embodiments, controller 44 includes a speed module 54, a traction control module 56, a brake control module 58, and a motor control module 60. Speed module 54 receives as input accelerator signal 32 and based on accelerator signal 32 determines a driver intended speed 62. Traction control module 56 receives as input intended speed 62, wheel speed signal 42, and motor speed signal 45. Traction control module 56 determines loss of traction, referred to as a traction event, based on a comparison of intended speed 62 and wheel speed signal 42. Alternatively, traction control module 56 determines a traction event based on a comparison of motor speed signal 45 and intended speed 62. When a traction event occurs, traction control module 56 determines a commanded speed 64 and/or commanded torque 66.

Brake control module 58 receives as input brake signal 38. Based on brake signal 38, brake control module 58 generates brake signal 38 transmitted to brake 46 of FIG. 1. Motor control module 60 receives as input commanded speed 64 and commanded torque 66. Motor control module 60 generates motor signal 52 to motor 12 of FIG. 1 in accordance with commanded speed 64 and/or commanded torque 66. Thus, by controlling motor 12 via motor signal 52, the speed of driven wheels 16A and 16B is controlled during the traction event.

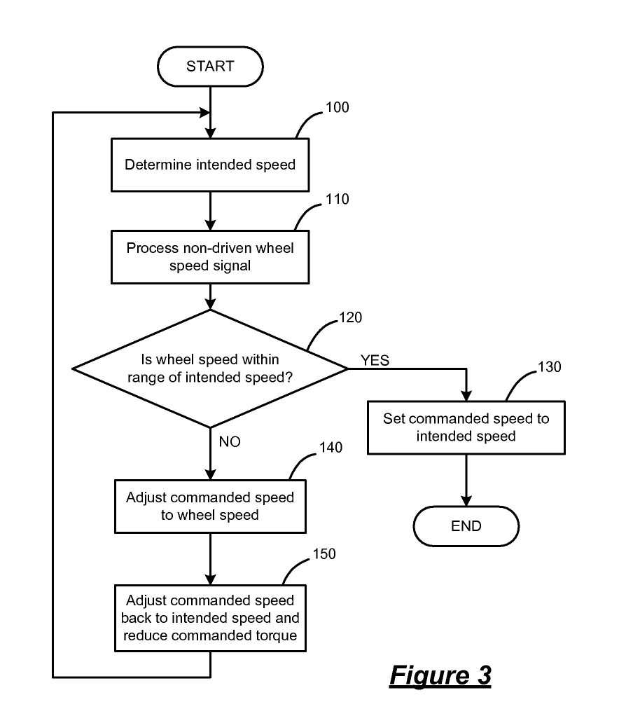

FIGS. 3-6 illustrate various embodiments of a closed loop traction control application as performed by traction control module 56. The traction control application may be continually run throughout a drive cycle. For example, in accordance with various embodiments, controller 44 can execute the traction control application every twenty milliseconds. As can be appreciated, the operations of the traction control application can be executed in any order. Therefore, the following examples are not strictly limited to the sequential execution illustrated in FIGS. 3-6.

In FIG. 3, based on accelerator signal 32, intended speed 62 is determined at 100. Wheel speed signal 42 is received and a non-driven wheel speed is determined from wheel speed signal 42 at 110. Intended speed 62 and the non-driven wheel speed are evaluated at 120. If the non-driven wheel speed is within a predetermined desired range of intended speed 62 at 120, commanded speed 64 is set equal to intended speed 62 at 130. Otherwise, if the non-driven wheel speed is outside of the predetermined desired range of intended speed 62, commanded speed 64 is adjusted to non-driven wheel speed at 140. Commanded speed 64 is then adjusted back to intended speed 62 and commanded torque 66 is reduced at 150. Thus, controlling the speed of driven wheels 16A and 16B during a traction event via motor 12. Thereafter, commanded speed 64 is adjusted and commanded torque 66 is reduced until the non-driven wheel speed falls within the desired range of intended speed 62 at 120.

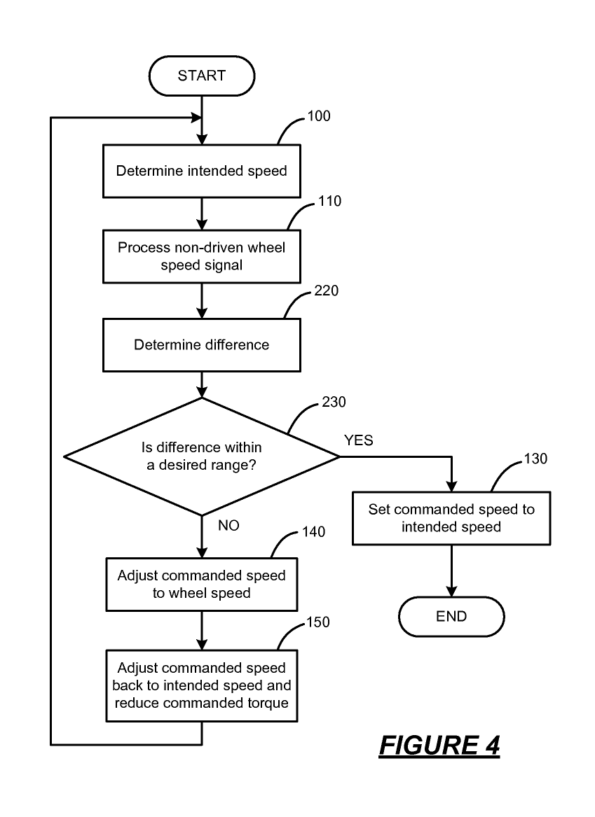

In FIG. 4, based on accelerator signal 32, intended speed 62 is determined at 100. Wheel speed signal 42 is received and a non-driven wheel speed is determined from wheel speed signal 42 at 110. In various embodiments, a difference between the non-driven wheel speed and intended speed 62 is computed at 220. The evaluation in 120 of FIG. 3 is replaced with the evaluation in 230 where the difference is compared to a predetermined desired range. If the difference is within the predetermined desired range at 220, commanded speed 64 is set equal to intended speed 62 at 130. Otherwise, if the difference is outside of the predetermined desired range at 220, commanded speed 64 is adjusted to non-driven wheel speed at 140. Commanded speed 64 is then adjusted back to intended speed 62 and commanded torque 66 is reduced at 150. Thus, controlling the speed of driven wheels 16A and 16B during a traction event via motor 12. Thereafter, commanded speed 64 is adjusted and commanded torque 66 is reduced until the non-driven wheel speed falls within the desired range of intended speed 62 at 120.

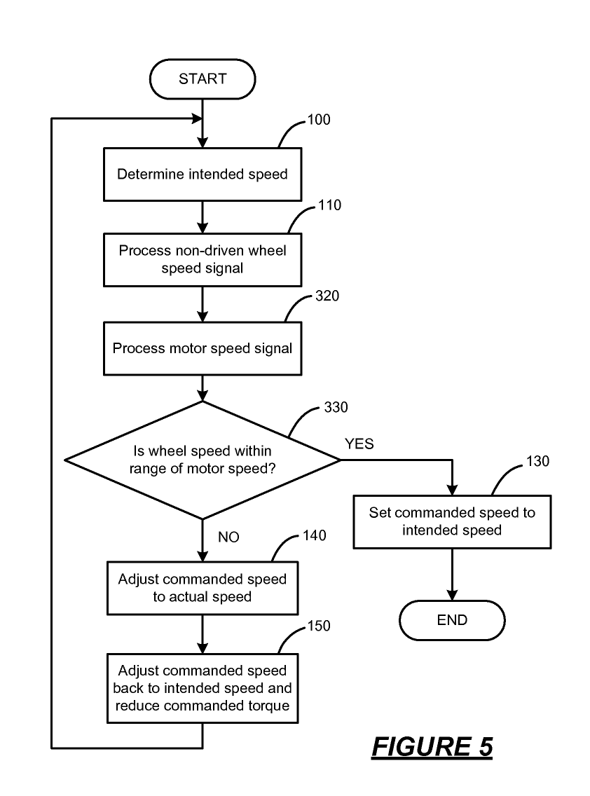

In FIG. 5, based on accelerator signal 32, intended speed 62 is determined at 100. Wheel speed signal 42 is received and a non-driven wheel speed is determined from wheel speed signal 42 at 110. In various embodiments, additional to FIG. 3, motor speed signal 45 is received and a motor speed is determined at 320. The evaluation in 120 of FIG. 3 is replaced with the evaluation in 330, where the wheel speed and the motor speed are evaluated at 330. If the wheel speed is within a predetermined desired range of the motor speed at 330, commanded speed 64 is set equal to intended speed 62 at 130. Otherwise, if the wheel speed is outside of the predetermined desired range of the motor speed, commanded speed 64 is adjusted to non-driven wheel speed at 140. Commanded speed 64 is then adjusted back to intended speed 62 and commanded torque 66 is reduced at 150. Thus, controlling the speed of driven wheels 16A and 16B during a traction event via motor 12. Thereafter, commanded speed 64 is adjusted and commanded torque 66 is reduced until the non-driven wheel speed falls within the desired range of intended speed 62 at 120.

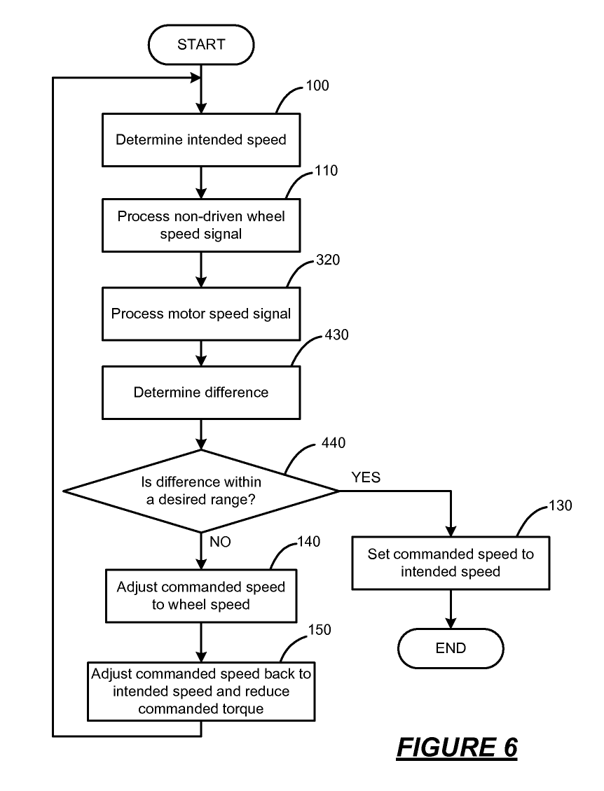

In FIG. 6, based on accelerator signal 32, intended speed 62 is determined at 100. Wheel speed signal 42 is received and a non-driven wheel speed is determined from wheel speed signal 42 at 110. Motor speed signal 45 is received and a motor speed is determined at 320. In various embodiments, a difference between the wheel speed and the motor speed is computed at 430. The evaluation in 330 of FIG. 5 is replaced with the evaluation in 440 where the difference is compared against a predetermined desired range. If the difference is within the predetermined desired range at 440, commanded speed 64 is set equal to intended speed 62 at 130. Otherwise, if the difference is outside of the predetermined desired range at 440, commanded speed 64 is adjusted to non-driven wheel speed at 140. Commanded speed 64 is then adjusted back to intended speed 62 and commanded torque 66 is reduced at 150. Thus, controlling the speed of driven wheels 16A and 16B during a traction event via motor 12. Thereafter, commanded speed 64 is adjusted and commanded torque 66 is reduced until the non-driven wheel speed falls within the desired range of intended speed 62 at 120.

Referring back to FIG. 1, the axles 17A and 17B may also be coupled to a limited slip device 70. Limited slip device 70 is torque bias actuated. If either driven wheel 16A or 16B experiences a reduced torque load, limited slip device 70 automatically replaces the torque applied to the lighter loaded wheel by redirecting the torque to the wheel which has more traction. Control of limited slip device 70 by controller 44 is not required. Rather, limited slip device 70 can be independently controlled or mechanically actuated. Limited slip device 70 operates during motoring and braking, and in forward and reverse directions.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A traction control system for a light-weight utility vehicle, comprising:
a wheel speed sensor that generates a wheel speed signal in accordance with a rotational speed of a non-driven wheel of the utility vehicle;
an accelerator position sensor that generates an accelerator signal in accordance with a position of an accelerator pedal of the utility vehicle; and
a controller that receives the wheel speed signal and the accelerator signal, that determines an intended speed based on the accelerator signal, and that determines a substantially actual wheel speed based on the wheel speed signal, and based on a comparison of the substantially actual wheel speed and the intended speed, the controller controls rotation of at least one driven wheel by adjusting at least one of a commanded speed and a commanded torque when the substantially actual wheel speed is outside of a desired range of the intended speed.

2. The system of claim 1, the controller configured to adjust commanded speed to the wheel speed when the wheel speed is outside of the desired range of the intended speed.

3. The system of claim 2, the controller further configured to adjust commanded speed to the intended speed while reducing the commanded torque when the substantially actual wheel speed is outside of the desired range of the intended speed.

4. The system of claim 3, the controller configured to continually adjust the commanded speed and reduce the commanded torque every twenty milliseconds until the substantially actual wheel speed is within the desired range of the intended speed.

5. The system of claim 1, further comprising a limited slip device coupled to an axle between driven wheels of the utility vehicle, the limited slip device is torque bias actuated to control torque between driven wheels of the utility vehicle.

6. The system of claim 1, the controller further computes a difference between the substantially actual wheel speed and the intended speed and adjusts the commanded speed and the commanded torque when the difference between the substantially actual wheel speed and the intended speed is outside of a desired range.

7. The system of claim 1, further comprising:
a motor speed sensor that generates a motor speed signal based on a rotational speed of the motor; and
the controller configured to receive the motor speed signal, determine a motor speed based on the motor speed signal, and based on a comparison between the substantially actual wheel speed and the motor speed, the controller configured to control a rotational speed of the at least one driven wheel by adjusting the commanded speed and the commanded torque when the substantially actual wheel speed is outside of a desired range of the motor speed.

8. The system of claim 7, the controller further configured to compute a difference between the substantially actual wheel speed and the motor speed and adjust the commanded speed and the commanded torque when the difference between the substantially actual wheel speed and the motor speed is outside of a desired range.

9. A traction control system for a light-weight utility vehicle, comprising:
a wheel speed sensor that generates a wheel speed signal in accordance with a rotational speed of a non-driven wheel of the utility vehicle;
a motor speed sensor that generates a motor speed signal in accordance with a rotational speed of a motor of the utility vehicle; and
a controller that receives the wheel speed signal and the motor signal, that determines a motor speed based on the motor speed signal, and that determines a substantially actual wheel speed based on the wheel speed signal, and based on a comparison of the substantially actual wheel speed and the motor speed, the controller controls rotation of at least one driven wheel by adjusting at least one of a commanded speed and a commanded torque when the substantially actual wheel speed is outside of a desired range of the motor speed.

10. The system of claim 9, the controller, when the substantially actual wheel speed is outside of a desired range of the motor speed, configured to adjust the commanded speed to reach the wheel speed and then adjust the commanded speed to reach an intended vehicle speed while reducing the commanded torque.

11. The system of claim 10, further comprising an accelerator position sensor that generates an accelerator signal based on a position of an accelerator pedal of the utility vehicle and the intended speed is determined based on the accelerator signal.

12. The system of claim 10, the controller configured to continually adjust the commanded speed and the commanded torque every twenty milliseconds when the substantially actual wheel speed signal is outside of the desired range of the motor speed.

13. The system of claim 10, the controller configured to compute a difference between the substantially actual wheel speed and the motor speed and adjust the commanded speed and the commanded torque when the difference between the substantially actual wheel speed and the motor speed is outside of a desired range.

14. The system of claim 9, the controller configured to command the intended speed when the substantially actual wheel speed signal is within the desired range of the motor speed.

15. A traction control method for a light-weight utility vehicle, comprising:
processing an accelerator signal received from an accelerator position sensing device coupled to an accelerator pedal;
processing a wheel speed signal received from a wheel speed sensing device coupled to a non-driven wheel;
adjusting at least one of a commanded speed and a commanded torque when the wheel speed signal is outside of a desired range of the accelerator signal; and
controlling a motor in accordance with the commanded speed and the commanded torque.

16. The method of claim 15, the adjusting comprising adjusting the commanded speed to the wheel speed signal.

17. The method of claim 16, the adjusting further comprising adjusting the commanded speed to the accelerator signal while reducing the commanded torque.

18. The method of claim 17, the adjusting is performed every twenty milliseconds.

19. The method of claim 15, further comprising:
processing a motor speed signal received from a motor speed sensing device coupled to at least one of a motor and an output member of the motor; and
adjusting the at least one of the commanded speed and the commanded torque if the wheel speed signal is outside of a desired range of the motor speed signal.

20. The method of claim 20, further comprising:
determining a difference between the motor speed signal and the wheel speed signal; and
adjusting the at least one of the commanded speed and the commanded torque if the difference is outside of a desired range.

21. The method of claim 15, further comprising providing a limited slip device that is torque bias actuated to control torque between rear driven wheels of the utility vehicle.
